(19) United States
(12) Patent Application Publication
(10) Pub. No.: US 2008/0131854 A1
(43) Pub. Date: Jun. 5, 2008

(54) Plaster your stress

(76) Inventor: Roger Lennart Andersson, Goteborg (SE)

Correspondence Address: Roger Andersson, Nedre Fogelbergsgatan 4A, Goteborg, S-41128, omitted

(21) Appl. No.: 11/607,967

(22) Filed: Dec. 4, 2006

(51) Int. Cl. G09B 19/22; A63F 3/00

(52) U.S. Cl. 434/262; 273/243

(57) ABSTRACT

A board game is provided on the subject of stress education, stress management and stress reduction to be played by a plurality of players. A plurality of cards, each said card having imprinted thereon a suggestion for either a physical or mental exercise that has either an instant, and/or long term stress reducing effect. Explanations are included as to why the activities reduce stress, and questions are raised on the subject to reflect on, or to discuss with your fellow players. Methods to use the board game are included.

### BACKGROUND OF THE INVENTION

Stress and stress related diseases such as “burn-out” and heart disease can be horrific for people who become victims. For society the costs for stress related disorders are enormous.

There are a variety of techniques available for stress education, stress management and stress reduction, and the solutions are highly individual. An importance for many people is not to be too lonely in their search for stress reduction, but to find ways to share experiences and thoughts with others. A board game, set up with a variety of both mental and physical exercises, would be a good platform for both learning and reducing stress. Together!

The use of board games as a means of entertainment and education is well known in the prior art. In general the game has the purpose that someone strives to win the game through luck or performance. The focus of the players is to win the game—Not to lose! You win through coming first to a point somewhere on the board, getting the most imaginary money, or points etc. Some of the most popular games in history have this approach.

This method of competitive play, where the focus and excitement comes from the competition, unfortunately does not fit a board game relating to stress. Many people that suffer from stress and stress related disorders need to relax from pressure and competition in order for healing to occur. There is a need for a game with less competition and more inspiration. Why not a game where the loser wins! A board game dealing with various ways of stress education, stress management, and stress reduction would have the advantage that it encourages group activities as well as reflection, and discussions on various techniques. It would inspire the players to go home and practice what they've learned and learn even more.

Another general shortcoming in the prior art is that board games usually are imaginary in the sense: You might win a board game and for example get “rich within the game”. But when the game is over you don't have more money in your own pockets. Because it was “just a game” There is a need to further the art of entertaining board games; bridging the imaginary world of the game to the world of reality. For an educational game relating to stress this approach would be particularly important. It would be more than “just a game”.

In U.S. Pat. No. 5,435,565 imaginary situations and actions representing stressful categories, cheerful categories relating to stress. However the invention does not seem to offer a variety of stress reduction methods to actually reduce the stress levels of a variety of players. Nor does it seem to have a clear ambition to educate or distribute the variety of knowledge that is available today on the subject of stress management.

However, in U.S. Pat. No. 5,362,062 there seems to be an ambition to actually reduce the stress level with the participants through pillow-fight. This approach however is a narrow approach to stress reduction, stress education, and stress management, and does not offer the variety that would be needed with a broader group of people playing the game. Different techniques appeal and work differently for different people. And there is a need for a board game that offers a variety of solutions.

U.S. Pat. No. 5,215,309 simulates different health oriented problems, but they are mainly simulations “within the game”. There are no solutions to offer actual stress relief.

U.S. Pat. No. 4,344,625 discusses self improvement, particularly dieting.

U.S. Pat. No. 5,556,100 is an educational game of the immune system

U.S. Pat. No. 6,893,264 is a professional educational game.

None of the games above focus on stress education, stress reduction and stress management.

There is a need for a board game on the topic of stress management that encourages people of all ages and backgrounds to participate in both group activities, discussions, reflections and individual activities that actually offer instant stress relief, such as deep breathing, massage etc. And also inspire people to identify stressors in their own life and change long time destructive habits. These types of activities differ from earlier board games in that they have the ambition to have a direct effect on the persons stress levels, not only in an “imaginary game world” but in that persons' real life as well. It would be an advantage to play a game on the subject of stress where the main focus is to get inspired for a variety of ways for all participants to manage their stress in their own life. And in the process having fun with your friends and actually try different techniques, some offering instant stress relief. Since people has such diverse solutions to reduce their stress, such a board game would need to incorporate a variety of activities for stress management techniques, both from the western world, discussing various issues on lifestyle, food and nutrition, physical exercises as well as mental exercises like visualizations, focus and concentration techniques, but also incorporate techniques from other parts of the world like yoga. A board game encouraging activities with this diverse approach towards stress has a better chance to inspire people of all ages and with different backgrounds, and outer circumstances in life. A board game that is not only fin to play, but also has the ambition to actually help people to help themselves live a life with less stress.

### BRIEF SUMMARY OF THE INVENTION

An educational game is provided, comprising of a board and a plurality of cards. As you play the game you pick up different cards that have text suggesting a stress reducing action to be performed by one, or two or all players simultaneously. It is recommended to play between 2-6 people. More than merely suggesting actions, an explanation on every card is provided as of how the particular stress reducing tip would affect you. To encourage reflection and discussion on the particular exercise or stress reduction tip, there is also a question directed to the player who picked up the card as how this tip would relate to his or her own reality.

### BRIEF DESCRIPTION OF THE SEVERAL VIEWS OF THE DRAWING

Further objects, features and advantages of the present invention will become more readily apparent from the following description of the invention when taken in conjunction with the accompanying drawings.

While this invention is susceptible of embodiment in many different forms, there is shown in the drawings and will herein be described in detail, one or more specific embodiments, with the understanding that the present disclosure is to be considered merely an exemplification of the principles of the invention and is not intended to limit the invention only to the embodiments described and illustrated.

FIG. 1A is a plain view of a board game showing the playing path.

FIG. 1B is a close up on the path showing 3 different spaces frequent along the game path, shaped as plasters, where you put your token depending on the number the die show, each form indicating that the player is to pick up a corresponding card.

FIG. 2A is the upside of an informational card shaped as an “hour glass” plaster—for exercises that might take a minute or more to perform

FIG. 2B is the backside, where text is written. This drawing explains what the card has written in broader terms. There are approximately 15 cards of this shape, and on each card there is a different action suggested. There is also an explanation as to why the action would have a stress reducing effect, and there is an indication as to how many stress pressure points you lose, in the game if you participate in the action.

FIG. 3A is the upside of an informational card shaped as an oblong plaster—for individual exercises.

FIG. 3B is the backside, where text is written. This drawing explains what the card has written in broader terms. There are a number of approximately 30 cards of this shape, and on each card there is a different action suggested. There is also an explanation as to why the action would have a stress reducing effect, and to the left it says how many stress-pressure points you lose—in the game if you participate in the action

FIG. 4A is the upside of an informational card shaped as a round plaster—for exercises for everyone participating in the game, around the table.

FIG. 4B is the backside, where text is written. This drawing explains what the card has written in broader terms. There are approximately 20 cards of this shape, and on each card there is a different action suggested. There is also an explanation as to why the action would have a stress reducing effect, and to the left it says how many stress pressure points you lose in the game, if you participate in the action

FIG. 5A is a drawing of what the construction that holds cards together looks like.

### DETAILED DESCRIPTION OF THE INVENTION

An educational game is provided, comprising of a board and a plurality of cards. The game is on the subject of stress education, stress management and stress reduction to be played by a plurality of players. It is recommended to play between 2-6 people.

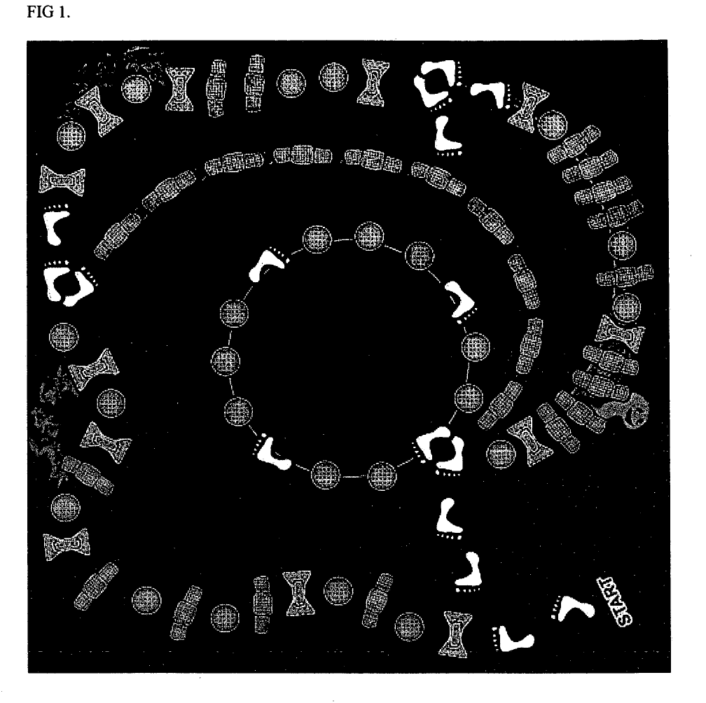

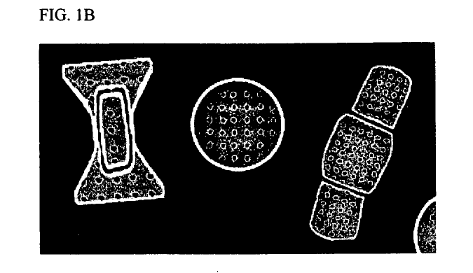

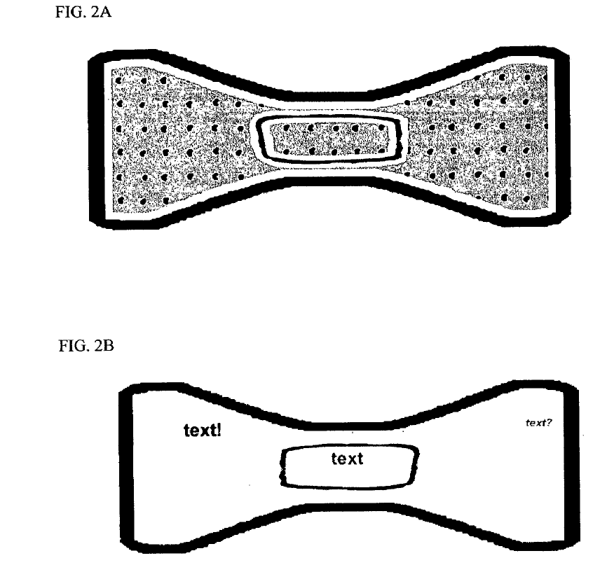

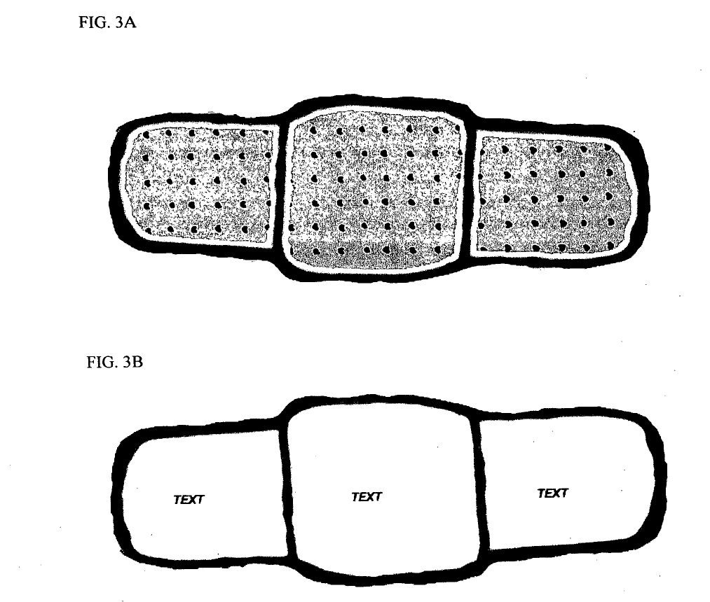

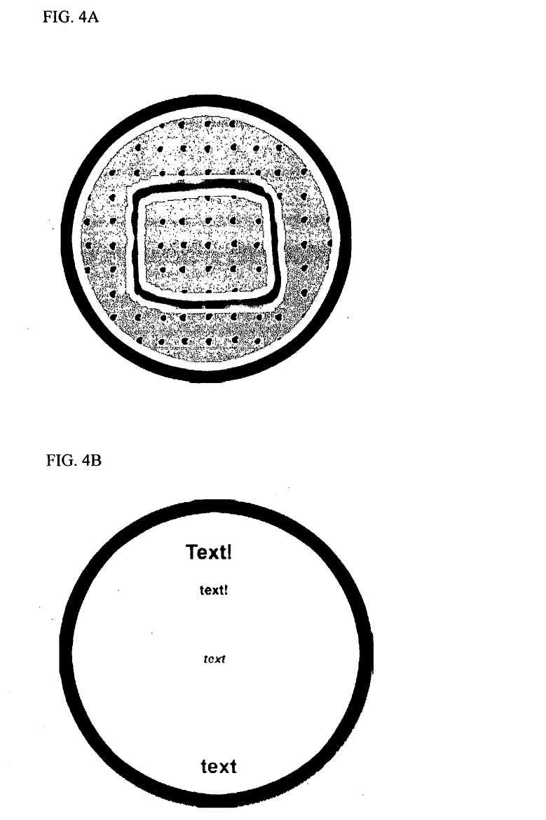

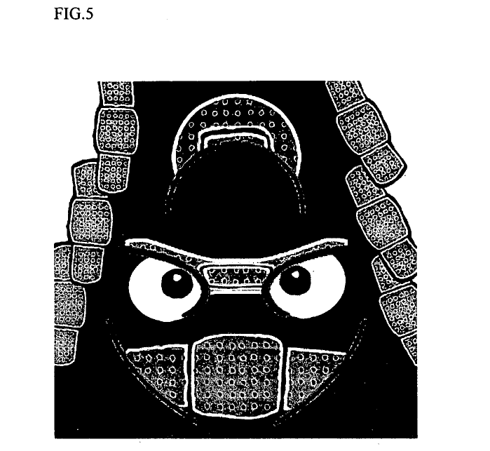

The game board FIG. 1 has a start area, and a playing path. There is plurality of playing pieces and a single die to determine how many steps the player is to move along the path of the game board. The reason for the shape of plasters on the board and cards is that the symbolic idea of a “plaster” is to heal and protect. The symbol of different plasters on both the board where you step, and the cards you read is to remind the players that the action asked for has a healing or protecting ambition. The path of the board has spaces where you walk with your playing pieces. They are shaped like plasters: FIG. 1B. As you walk along the path you will stop as the game progresses step on several spaces with “plasters”. There you pick up a corresponding card having imprinted thereon a suggestion for either an instant, or long term stress reducing activity, for one, two or all players. On the card is also an indication how many stress pressure points you lose by performing the activity. A player can always say no to any of the actions suggested on the card. However, if they do participate in the action asked for they lose points, and if they do say no and don't wish to participate, they still lose points, since “saying no” can reduce stress in real life. More than merely suggesting real stress reducing actions, an explanation on every card is provided to explain how, and sometimes why, the particular stress reducing tip is believed to actually reduce stress. There is also a question on the back of the card as to how the activity suggested relates to the players individual real life. There are three types of shaped cards; FIG. 3A, FIG. 3B oblong—for individual exercises, FIG. 2A, FIG. 2B, hour glass—for exercises that might take a minute or more to perform, and FIG. 4A, FIG. 4B round—for all players around the table at the same time.

All These cards include activities that can be in different forms or combinations of different forms such as various types of physical exercises such as for example:
Breathing exercises
Stretching exercises
Other physical exercises
Yoga exercises

Mental exercises for example:
Visualizations
Focus and concentration
Forgiveness exercises
Meditations
Symbolic gestures

The exercises can be individual, such as exercise in:
Taking Time Out
Increasing your hands blood flow through having them under warm water

Or group exercises for everyone around the table, such as:
A ring of neck-massage
Yawning
Turning off your mobile
Taking off your shoes

An important factor is that, within the game, there is a great variety of approaches to stress education, stress management, and stress reduction. There should be something for everyone! The ambition is that the game shall appeal to a variety of individuals of different ages, backgrounds and personality types. Variety is a key word!

Additionally the game has a number of cards representing stress pressure-points. Unlike many other games, the set up is to avoid a competitive climate while playing the game. The rules are constructed so that the loser wins! You start with for example 100 stress pressure points, and the one who first loses his/her points wins! The loser wins! Or another way to play the game is for the players at start to decide a time when to finish. When time is up, whoever has the least points left wins the game!

Another construction to make the game less competitive is that many cards are aimed to more than the person who picked up the card. As for the round cards all players are in on the action asked for, and lose points when one player picks up a round card. Sometimes with the other cards the player, to the right or left of the person picking up the card, is engaged in the activity and lose points.

There is also a special construction FIG. 5 that holds the cards in place.

What is claimed as new and what is desired to secure by Letters Patent of the United States is:

1. A board game on the subject of stress education, stress management and stress reduction to be played by a plurality of players, comprising:
(a) A game board having a start area, and a playing path
(b) A plurality of playing pieces
(c) A single die to determine how many steps the player is to move along the path of the game board
(d) A number of cards representing stress pressure-points
(e) A plurality of cards, each said card having imprinted thereon a suggestion for either an instant, or long term stress reducing activity with a great diversity; for one, two or all players, an explanation as to why the activity reduces stress, and a question for reflection or discussions as of how the activity may relate to the players individual real life.
(f) A construction that holds the cards in place.

2. A method of teaching about the variety of techniques available for instantly and/or in the long term reduce stress and the risk for stress related disease to a plurality of players using the board game according to claim 1, comprising of:
(a) Positioning a marker token for each player at the start area of said game board.
(b) Distributing an equal number of stress-pressure points to each player.
(c) Using the die to advance the first players token the corresponding number of spaces on the game board.
(d) When the token is moved to a space representing the same shape as one of the cards, as explained in 1(e), the first player picks up such a card.
(e) Loudly reading the card suggesting either an instant, or long term stress reducing activity, to be performed either by the player himself, or by the player and one more of his playing friends, or by all players.
(f) Performing the activity.
(g) Continuing reading the card, as explained in 2(c) loud, learning the explanation as to why the activity reduces stress.
(h) Continuing reading the question on the card, as explained in 2(c) loud, reflecting and discussing how the activity performed, as explained in 2(d), could have impact in your daily life?
(i) Continuing reading the card as explained in 2(c) as to see how many stress pressure points as explained in 1(e) the player lose if he/she/they perform the activity explained in 2(d).
(j) Put back stress pressure points in the special card board construction as explained in 1(f) for information cards and stress pressure points.
(k) Move on to the next player, and repeat 2(b)-2(i) until one of the players has lost all his or her stress—pressure points. Alternatively play until a beforehand set time. At the time you finish the game the player who has lost most stress pressure points is the winner.

3. By use of the method according to claim 2 to use the cards in claim 1e to inspire for a variety of stress reducing techniques such as:
a) Breathing exercises
b) Physical exercises
c) Yoga exercises
d) Mental exercises
e) Visualizations
f) Focus and concentration exercises
g) Forgiveness exercises
h) Meditations
i) Taking Time Out
j) Food and nutrition knowledge
k) Massage exercises
l) Relationship exercises
m) Turning off your mobile
n) Taking off your shoes
o) Delegation exercises
p) Feng shui exercises
